(19) United States
(12) Patent Application Publication
(10) Pub. No.: US 2005/0014550 A1
(43) Pub. Date: Jan. 20, 2005

(54) Randomly controlled roulette game operation

(76) Inventor: Larry J. Rhoten, Lancaster, CA (US)

Correspondence Address: GENE W. ARANT, P.O. BOX 269, LINCOLN CITY, OR, 97367-0269, US

(21) Appl. No.: 10/766,065

(22) Filed: Jan. 29, 2004

Related U.S. Application Data
(63) Continuation-in-part of application No. 10/693,741, filed on Oct. 24, 2003.
(60) Provisional application No. 60/484,990, filed on Jul. 3, 2003.
(60) Provisional application No. 60/495,641, filed on Aug. 15, 2003.
(60) Provisional application No. 60/502,456, filed on Sep. 11, 2003.

(51) Int. Cl. A63F 13/00

(52) U.S. Cl. 463/17

(57) ABSTRACT

A method of controlling at least one of the launch time of the ball, the speed of rotation of the wheel, and the speed of movement of the ball, in such a way that none of those factors is under the immediate control of a game manager; and displaying information to confirm the randomness of the operation.

### PRIORITY CLAIM

I claim priority of my copending U.S. patent application Ser. No. 10/693,741 filed Oct. 24, 2003; and of my three U.S. Provisional Applications Ser. No. 60\484990 filed Jul. 3, 2003; Ser. No. 60\495641 filed Aug. 15, 2003; and Ser. No. 60\502456 filed Sep. 11, 2003.

### FIELD OF THE INVENTION

This invention relates to improvements in gaming devices, and particularly to roulette table games, or video simulations thereof, or in coin operated gaming devices or in internet gaming.

### BACKGROUND OF THE INVENTION

In the game of roulette, which is played at many gaming houses in the United States and elsewhere, a dealer employed by the gaming house releases a ball which then travels around the periphery of a rotating wheel having circumferentially arranged stopping places, until the ball finally stops at a particular stop. The stopping place of the ball, and a number associated with that stopping place, determines whether particular players have won or lost on their bets, and also whether the house has won or lost.

Although it is perhaps a groundless concern, some players worry that the dealer, because of greater familiarity with the apparatus and its mode of operation, may be able to cause the ball to stop at a location favorable to the house but which will cause the players to lose.

Many players may therefore wish for a procedure that would ensure that the dealer cannot and has not “rigged” the play.

### SUMMARY OF THE INVENTION

According to my invention I have provided a method and apparatus for randomly controlling an actual or simulated roulette game, which ensures that a dealer or game management system cannot and has not “rigged” the play. Furthermore, my novel method not only operates the game in a random fashion, but also provides confirmation of that random operation to the player.

According to the presently preferred embodiment of my invention a Start Game signal is generated, and a Launch Signal causes an actual or simulated ball to be launched, in such a way that a dealer who may be in charge of the game has no direct physical contact with the ball during either its launch or its subsquent travel, and hence has no control over where the ball might stop.

According to the presently preferred embodiment of my invention a Start Game signal is remotely generated either by a dealer, by a Game Management System, or by a customer or player. The operation of the actual or simulated game then proceeds in a manner that is entirely random in one or more respects.

According to the presently preferred form of my novel method I utilize an electronically generated random time delay after the Start Signal and before the Launch Signal is generated. An isolated manually actuable activation means generates the Start Game signal which then energizes an electronic random time delay device. The conclusion of the random time delay causes the Launch Signal to be generated. A mechanical launch mechanism upon receiving the Launch Signal is capable of launching the ball along a desired path about the wheel periphery. A person who actuates the isolated manually actuable activation means, therefore, is unable to predict or control either the exact time the ball will be launched or its ultimate stopping place.

According to my invention any one of a number of different means may be used for communicating a Start Signal from the isolated manually actuable activation means to the random time delay device, including a hard-wired circuit, a radio transmitter, an infrared remote control, or the like.

Still further in accordance with the presently preferred form of my invention, the launching of the ball may be propelled by an electromagnetic action, by a release of air pressure, by spring action, or by other suitable means.

Further in accordance with the preferred form of my invention I also provide an apparatus which may be retrofitted into an existing roulette game table and which may then be used to carry out the purposes of my invention.

Also according to my invention, any one of various other kinds of random control may be applied to an actual or simulated game. My invention contemplates any kind of method or apparatus that may be used by a gaming establishment will meet the requirements of the relevant Gaming Commission or its equivalent.

In an actual game there may be an adjustment or variation in the one-time energy level imparted to the launch mechanism for launching the ball, or in the energy level that is imparted in either a steady-state or variable amount to an electric motor that drives the rotation of the wheel.

In a simulated or virtual game, the ball may have a simulated movement the speed of which may be subject to an initial selection, or which is subject to continuing adjustment, or which is subject to braking or deceleration at a selected level; or the movement of the ball may be stopped at the end of a predetermined discrete time interval.

According to my invention, in a simulated or virtual game shown in video, the operation may be either the same as it would be in a real physical embodiment of the game, or it may be different as suggested above. A simulated or virtual game may be coin-operated by the player or customer.

Still another aspect of my invention is conducting a game via the internet. The techniques are the same as for a video or virtual game. In addition, appropriate encryption techniques are used to keep communications confidential and prevent cheating.

### DRAWING SUMMARY

FIG. 1 is a schematic representation of the presently preferred apparatus in accordance with the invention;

FIG. 2(a) is a schematic diagram of a random time delay circuit and an associated visible time delay readout in accordance with the invention;

FIG. 2(b) is a wave diagram showing the timing relationships in the operation of the random time delay circuit of FIG. 2(a);

FIGS. 3a, 3b, and 3c illustrate in schematic form various types of launching mechanisms that may be utilized with my invention;

FIG. 4 illustrates a roulette game table retrofit apparatus in accordance with my invention, in which an opening is made in the wooden housing for the roulette wheel, and the launch mechanism is fitted into that opening;

FIG. 5 schematically illustrates a system for varying the electric motor speed to drive the wheel rotation;

FIG. 6 illustrates a physical arrangement of the motor drive according to FIG. 5;

FIG. 7 schematically shows an electronic system for controlling motor drive speed in accordance with FIGS. 5 and 6;

FIG. 8 shows a software system for operating a virtual or simulated game in which wheel rotation and operating results are electronically displayed; and

FIG. 9 illustrates an encryption system for communicating bets via internet to a remotely located gaming establishment.

### DESCRIPTION OF PREFERRED EMBODIMENT

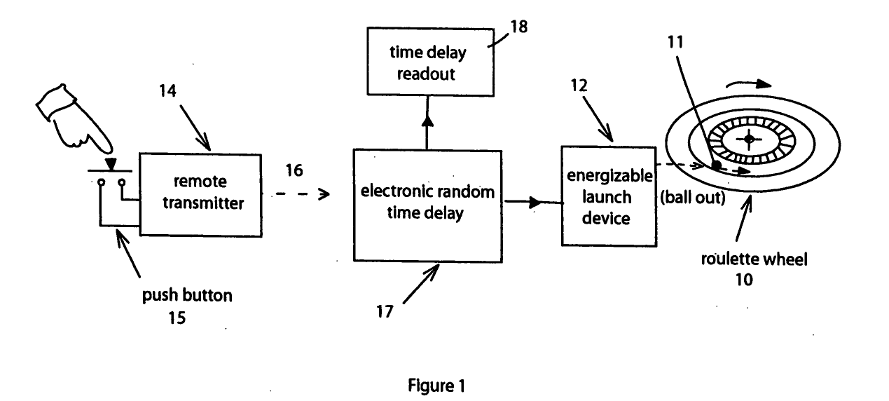

### (FIG. 1-4)

Referring now to the drawings, FIG. 1 shows a roulette wheel 10 onto which a ball 11 is to be launched. An energizable launch device or mechanism 12 is available to provide the actual launching of the ball. A remote transmitter 14 is controlled by a push button 15. When the button 15 is pushed the transmitter generates a Start Game signal 16 that is then transmitted to an electronic random time delay circuit 17. The transmission of the Start Signal 16 is represented in FIG. 1 by a dotted line and arrow, indicative of the fact that any of several different means may be utilized for communicating a Start Game signal to the electronic random time delay circuit 17. Also associated with the time delay circuit 17 is a time delay readout 18 which visibly indicate the actual amount of time that transpires after the start button 15 is pressed and before a Launch Signal is generated to energize the launch mechanism 12.

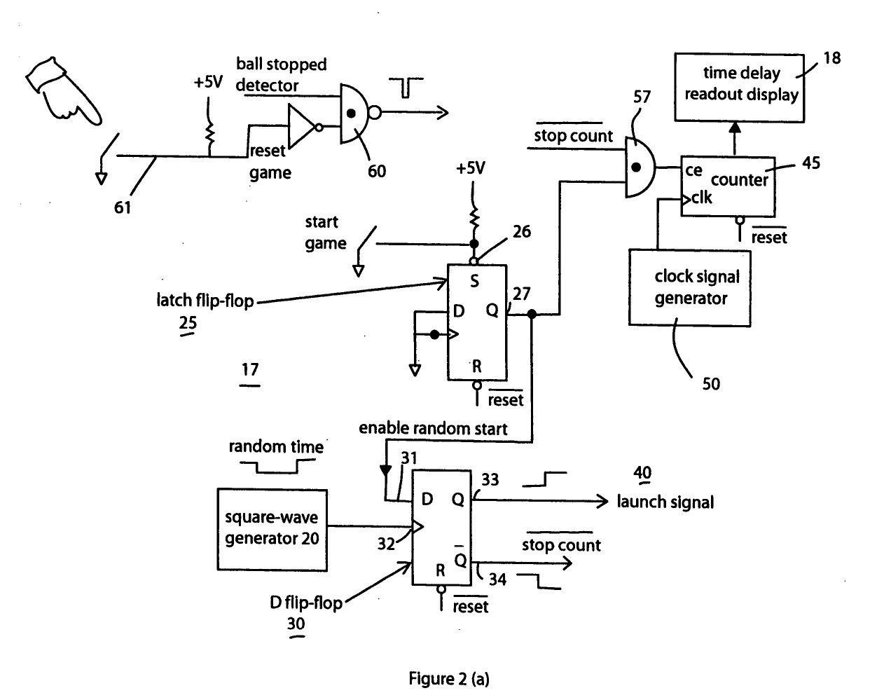

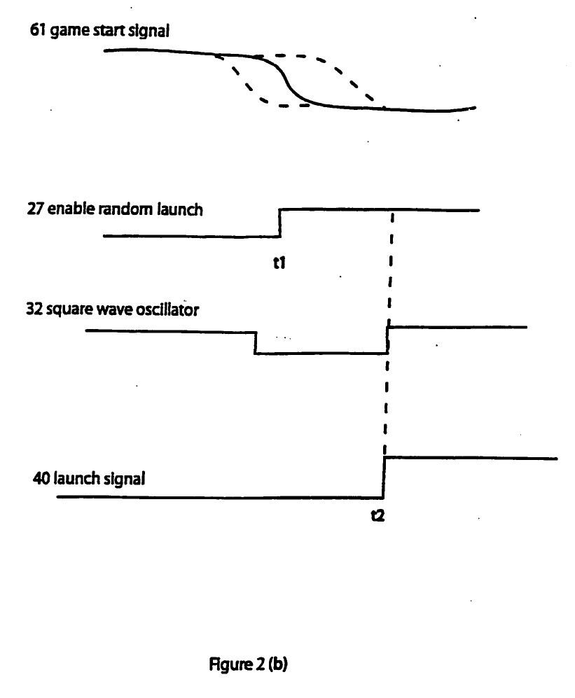

In accordance with the invention a random time period is generated by electronic circuitry as shown in FIG. 2. Referring now to FIG. 2(a) of the drawings, the principal operative circuit elements that create a random time delay period are a square-wave generator 20, a latching flip-flop 25, and a D flip-flop 30. The operation of the D flip-flop 30 is of unique importance and will be described first.

D flip-flop 30 has an input 31 which receives an Enable signal on output 27 from the latch 25, and an input 32 which receives the output signal of the square-wave generator 20. It also has a primary output terminal 33 from which a Launch Signal 40 is to be generated. The operation of the D flip-flop is such that an output signal on terminal 33 is only possible after the voltage signal on input 32 has raised from a low to a high voltage level. In other words, if the input signal received on terminal 32 from square-wave generator 20 is already high at the time the Enable signal starts, then nothing else will happen; flip-flop 30 will not then produce an output until its square-wave input on teminal 32 goes down to its lower voltage level and then later rises to the higher level.

FIG. 2(b) shows the time relationships resulting from the circuitry of FIG. 2(a). The Start Game signal applied to terminal 26 of latching flip-flop 25 causes the Enable signal on terminal 27 to rise to its higher level. That time is designated as t1. Assuming that the output signal on output terminal 32 of square wave generator 30 is still at a low level, a random time delay period extending from t1 to t2 will now take place. The time when the output terminal 32 of generator 30 rises to its high level is designated as time t2. The co-existence of the continuing Enable signal on line 27 at its high level and the change of terminal 32 to a high level then causes the D flip-flop 30 to generate a Launch Signal 40 on its output terminal 33.

The time interval between time t1 and time t2 is a randomly generated time interval. It will be understood that the operation of square wave generator 20 is not synchronized with anything else in the circuitry. The square wave genereator may, for example, be a free-running multivibrator with either equal or unequal time periods for its two output states. Alternatively, a high-frequency oscillator could be utilized with a frequency divider circuit to create a low frequency square wave output on terminal 32. By selecting a desired time period for the low voltage level output of generator 20 it is possible to generate random time delays that may be either a very small fraction of a second, or as much as several seconds, as may be desired. The random time delay interval will never exceed the duration of the low voltage level of the low frequency square wave output on terminal 32.

Clock Signal generator 50 is an independent circuit. The clock frequency is selected to be at least many times the frequency of the square wave output signal of generator 20. When the signal received on terminal 32 goes from low to high, there may then have been a rather large number of clock pulses which the counter 45 would have counted before the output signal of the generator 20 goes low again. The time delay count displayed on the readout device 18 may be calibrated in any desired units, since players or customers for the game will be primarily interested in seeing that the time delays are random and not pre-programmed.

Latching flip-flop 25 performs the function of receiving and storing the Start Game signal 16 generated from the remote transmitter 14, shown in FIG. 1. It is only while the output 27 of flip-flop 25 is at its high voltage level that the D flip-flop 30 can generate a Launch Signal 40 on terminal 33. Thus, D flip-flop circuit 30 acts like an “and” circuit in which the two inputs required to be present concurrently are (1) an Enable signal that has been received from output terminal 27 of latch 25 and continues to exist; and (2) the output of square wave generator 20 on terminal 32 having risen from its low to its high level and continuing to exist at that level.

During the time period that these two conditions exist concurrently, the counter 45 will count pulses from the clock generator 50 and provide a corresponding output to display 18. When the output voltage of the D flip-flop returns to its lower level the count will stop, under control of complementary output line 34 of D flip-flop 30.

Readout from display 18 is available from the time that the counting starts until the high output voltage level from D flip-flop 30 ends, at which time complementary output terminal 34 of the flip-flop generates a signal indicating that the count should be stopped. This signal on terminal 34 is combined through an “and” gate 57 with the output of latch 25, to instruct counter circuit 45 to stop counting. The accumulated time count will then remain visible for a period of time. Thus according to my invention I have provided a method and apparatus for randomly controlling an actual or simulated roulette game, which ensures that a dealer or game management system cannot and has not “rigged” the play. Furthermore, my novel method not only operates the game in a random fashion, but also provides information to the player so that he or she will be positively assured of that.

When the ball has stopped, and its stoppage has been electronically detected, one of the inputs required for “and” gate 60 is satisfied. The other requirement is a Reset Game signal on input line 61. When these two inputs co-exist, gate 60 then produces a negative output pulse acting as a reset signal which is delivered to each of three different places to return the ciruitry to initial starting condition. One of those three destinations is latch 25; another is D flip-flop 30; and the third is counter 45.

It is desirable for the random time count displayed in device 18 to remain visible for some period of time after the ball has stopped, in order to allow the players or customers adequate time to see and understand the random time delay count. This provides assurance to the customer of the randomness of operation.

With the circuitry as presently illustrated it is necessary for the dealer (or someone else) to send a Game Reset signal on input line 61; then, it is also necessary to push the remote button 15 in order to actually start a new game by again launching the ball. It would be possible to combine start button 15 and reset game line 61 into a single control, but that would not be the preferred approach.

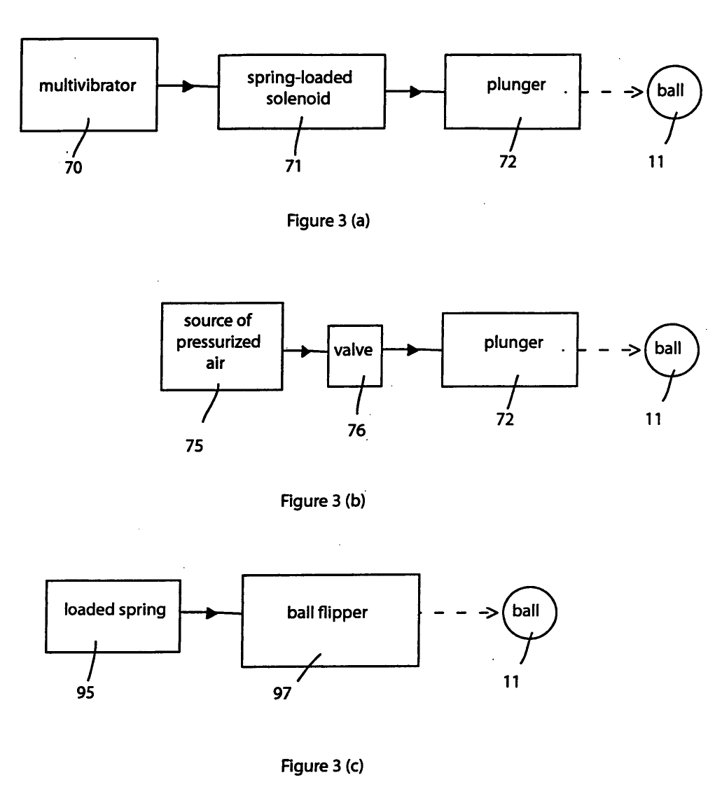

Referring now to FIGS. 3a, 3b, and 3c, it will be seen that driving power to launch the ball 11 may be achieved by any of three different methods. As shown in FIG. 3a a one-shot multivibrator 70 delivers a pulse of energy to a spring-loaded solenoid 71, which in turn drives a plunger 72 to launch the ball 11. As shown in FIG. 3b a source 75 of pressurized air may be selectively admitted through a valve 76 to drive the launch plunger 72. FIG. 3c indicates that a loaded spring 95 may be released to drive a ball flipper 97. I presently prefer the electromechanical action as provided by the solenoid 71. Although any one of these launch mechanisms may be utilized in accordance with my novel method, there are other known mechanisms that could, if desired, be used for that purpose.

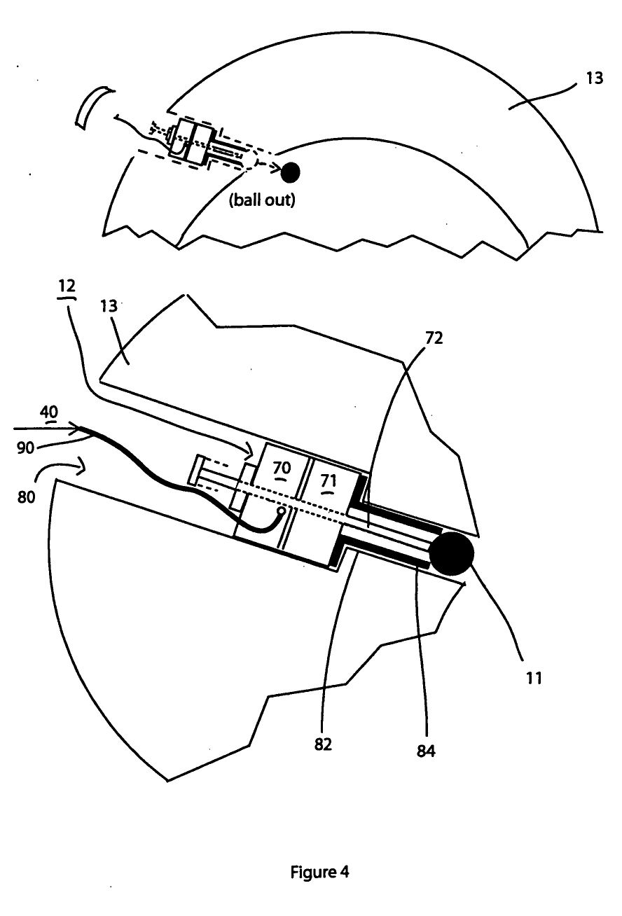

Referring now to FIG. 4, there is shown a retrofit apparatus in accordance with the presently preferred form of my invention that may be used to modify an existing roulette table to accomplish the purposes of my invention. A cable 90 receives the launch signal 40 from output 33 of D flip-flop 30. Housing 13 for the roulette wheel 10 has an opening 80 for receiving the Launch device 12. Launch device 12 includes the one-shot multivibrator 70 which is located in a relatively large rearward part of opening 80. A smaller forward portion 84 of opening 80 extends forwardly. A plunger 72 is reciprocably movable within forward housing 84 for launching the ball 11. The multivibrator 70 delivers a pulse of energy to a spring-loaded solenoid 71, also contained within housing portion 82, and which in turn drives the plunger 72 to launch the ball.

Method of Operation. Before a game is started it is necessary for the dealer to place the ball in the extreme forward end of opening 80 where it may be engaged by plunger 72. Then a Reset Game signal is applied to line 61. The apparatus is now ready to start a game. The next step is for the dealer—or a player or customer—to push the remote button 15, causing a Start Signal to be generated. This causes flip-flop 25 to latch in the Enable state, at time t1. When the output wave of square-wave generator 20 again rises to its high level, at time t2, a Launch Signal 40 will be generated and plunger 72 will launch the ball. At the same time, the counter 45 will have accumulated a count indicative of the random time delay that has transpired between the pushing of button 15 and the application of the Launch Signal to energize launch mechanism 12. A count that represents the random time delay is then visibly displayed in the display device 18. The dealer may then reposition the ball in preparation for another game. The time delay display will remain until another Game Reset signal is applied to line 61.

### Table Game With Random Wheel Speed

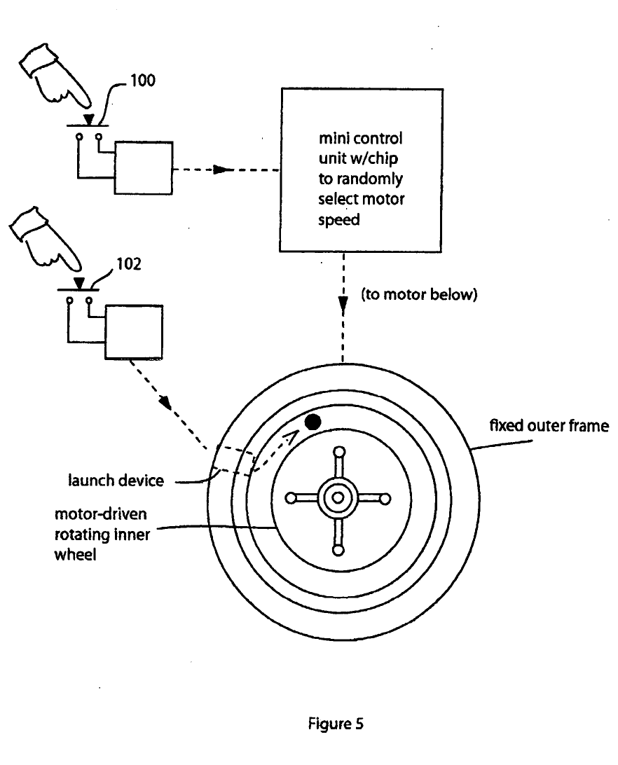

### (FIG. 5 Through 7)

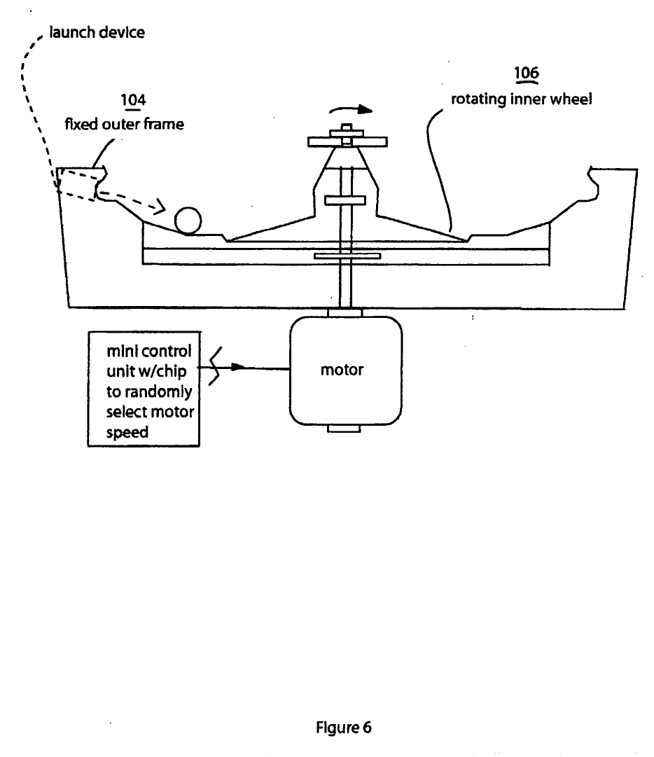

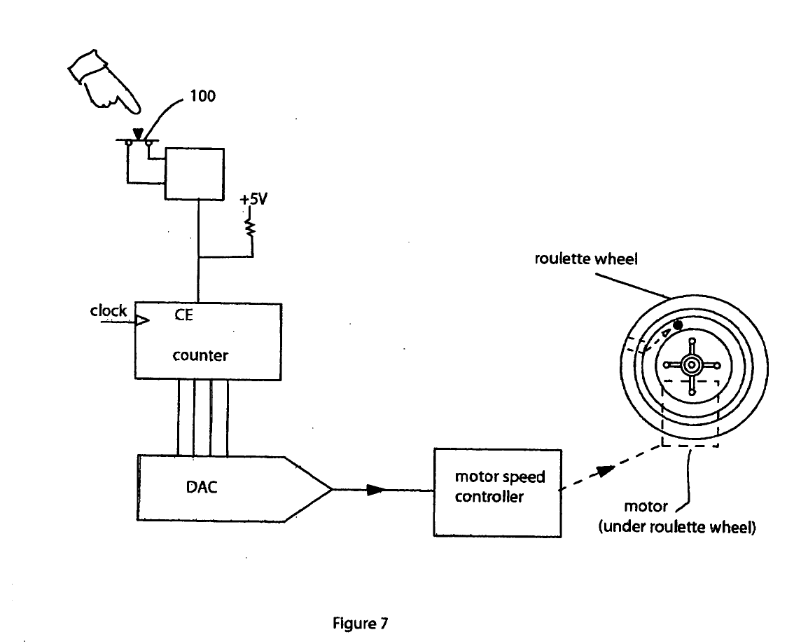

FIGS. 5 through 7 show a modified form of the table game in accordance with my invention. FIG. 5 schematically illustrates a system for varying the electric motor speed to drive the wheel rotation. FIGS. 5 and 6 show an apparatus in which the wheel includes a fixed outer part 104 and a rotatable inner part 106. As indicated at the top of FIG. 5, one momentary switch button 100 is pushed to select the energy level to be applied to the wheel, and then a second button 102 is pushed to start launching of the ball. FIG. 7 is a schematic drawing of an electronic circuit including a counter CE, enabled by the first push button 100, for selecting the energy level for motor energization and hence the motor drive speed.

### Simulated or Virtual Game

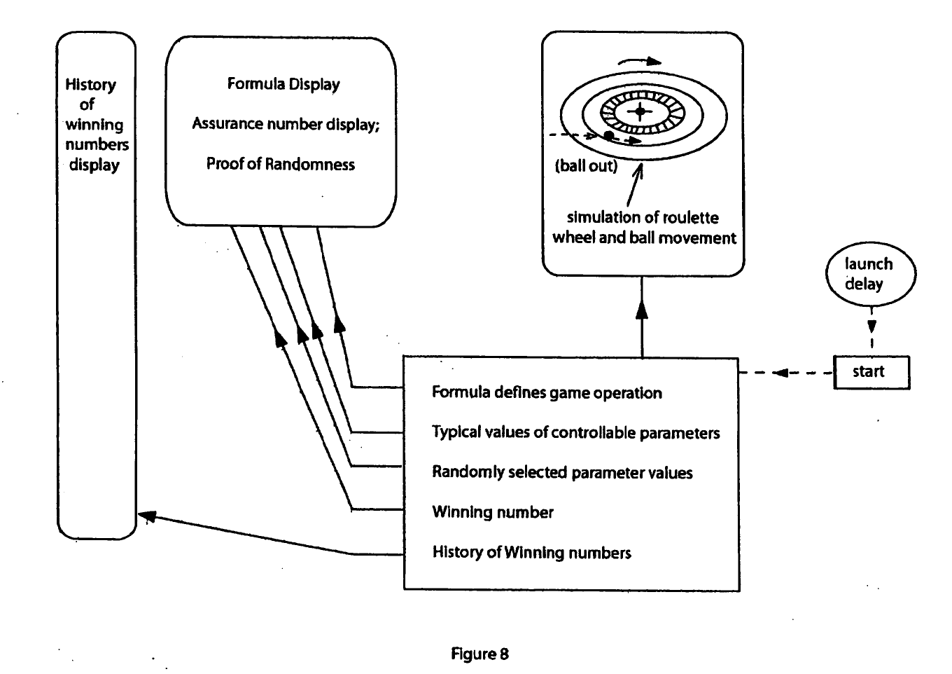

### (FIG. 8)

For Internet gaming or gaming conducted by other remote electronic communication it may be desirable to display a simulated movement of the wheel and ball on a screen that is being viewed by the player or customer. On the other hand, the player may be interested only in the final numbers that determine win or loss.

FIG. 8 illustrates a software system for operating a virtual or simulated game in which the player is provided with positive assurance that the operation has been random. The wheel rotation and ball movement are electronically simulated, and an electronic display of randomly selected numbers which control the operation provides proof that the operating results are randomly controlled.

### Internet Gaming With Player Protection Encryption

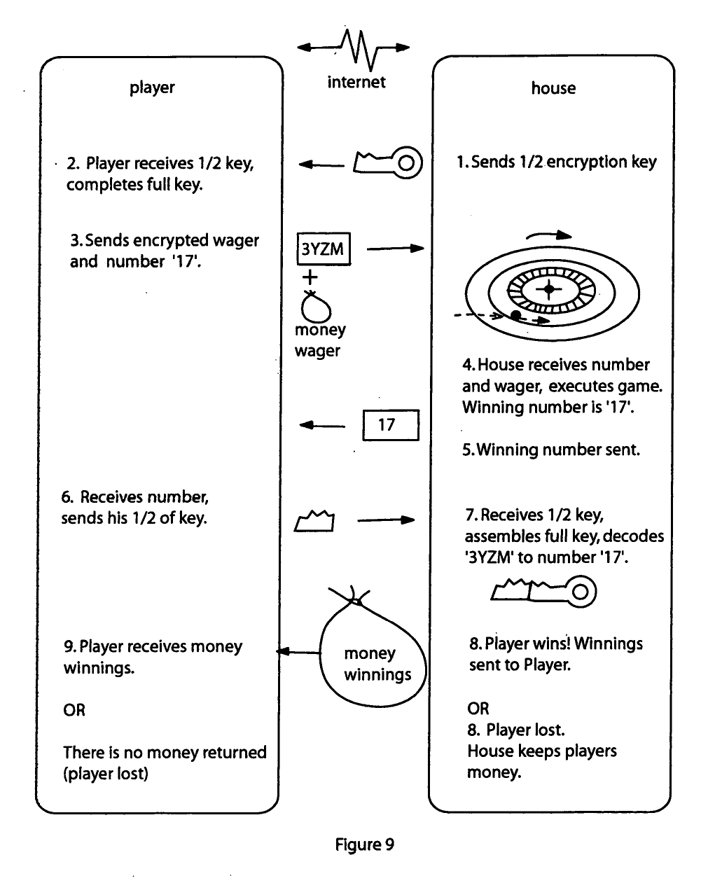

### (FIG. 9)

In Internet gaming encrypted communication is very desirable, if not asbolutely essential. FIG. 9 illustrates an encryption system for communicating bets via internet to a remotely located gaming establishment. The gaming house (or its computer) initially selects one-half of an encryption key and sends it to the player. The player then selects a second half for the encryption, but stores it in secure storage under his control pending outcome of the game. After the player has made a bet, the game has been played, and a winning number such as 17 has been determined, the player then sends the second half of his encryption code to the gaming house in order to collect his winning.

### OTHER ALTERNATIVES

According to my invention, any one of various kinds of random control may be applied to an actual game. In an actual game there may be an adjustment or variation in a one-time energy level imparted to the launch mechanism for launching the ball, or in an energy level that is imparted in steady-state fashion, or in an energy level that is imparted in a variable amount to an electric motor that in turn drives the rotation of the wheel. In a virtual or simulated game there may be any number of parameters that are randomely selected and controlled, and displayed to the customer as proof of the randomness of operation.

The presently preferred embodiment of my invention has been disclosed in detail in order to comply with requirements of the patent laws. It will be understood, however, that other modifications and variations will be understood by persons who are skilled in the art, and that the scope of my invention is to be judged only in accordance with the appended claims.

1. The method of operating an actual or simulated roulette game so as to avoid the appearance to a gamer of improper control by a dealer or gaming house, wherein at least one major aspect of the game operation is randomly controlled, and wherein upon conclusion of the game a visible display of proof of the randomness of the operation is provided to the gamer.

2. In a game wherein an actual or simulated roulette ball is launched about the periphery of an actual or simulated rotating wheel that has a plurality of circumferentially arranged numbered stopping places for the ball, and wherein final stopping of the ball at a particular numbered stopping place determines a win or loss result, a method of randomly controlling at least one of the launch time of the ball, the speed of rotation of the wheel, and the speed of movement of the ball, in such a way that none of those factors is under the immediate control of a game manager, and such that the game manager therefore has no control over the final numbered stopping place for the ball, comprising the steps of:
selecting a launch mechanism capable of actually or apparently launching the ball along a desired path about the wheel periphery;
selecting a randomly operating electronic control system that is capable of randomly starting the launch, energizing the launch mechanism, the speed of rotation of the actual or simulated wheel, and/or the movement speed of the actual or simulated ball;
initiating operation of the randomly operating electronic control system so as to then cause the actual or simulated ball to stop at a numbered stopping place;
displaying the identity of a numbered stopping place that represents a winning number; and
displaying information to the customer to confirm the randomness of the game operation in arriving at that winning number.

3. The method of operating an actual or simulated game of roulette, in which a electrical Start Signal is generated, a random time delay signal is then electronically generated in response to the Start Signal, and in response to the conclusion of the random time delay signal a Launch Signal is generated for launching a roulette ball.
